(19) United States
(12) Patent Application Publication
(10) Pub. No.: US 2010/0245109 A1
(43) Pub. Date: Sep. 30, 2010

(54) Programmable, modular lighting systems: Apparatus and method

(75) Inventors: Richard D. Ashoff, Newport Beach, CA (US); James R. Zarian, (US)

Correspondence Address: James R. Zarian, 2707 Blue Water Dr., Corona del Mar, CA, 92625, US

(73) Assignee: Richard d. Ashoff

(21) Appl. No.: 12/662,051

(22) Filed: Mar. 30, 2010

Related U.S. Application Data
(60) Provisional application No. 61/202,705, filed on Mar. 30, 2009.
(60) Provisional application No. 61/282,589, filed on Mar. 4, 2010.

(51) Int. Cl. G05B 19/02; F21S 4/00; F21V 7/04

(52) U.S. Cl. 340/825.22; 362/249.02; 362/613

(57) ABSTRACT

Programmable, modular lighting systems configured to resist environmental hazards for functional and/or decorative applications. The programmable, modular lighting systems may further include programs and communication means. The lighting modules and systems may additionally include environmentally resistant provisions such as auxiliary components and fixtures. The lighting modules may be arranged to form arrays or be arrayed into environmentally resistant systems for functional and/or decorative applications.

### CLAIM OF PRIORITY

This application is a non-provisional patent application claiming priority to U.S. Provisional Patent Application No. 61/202,705, filed on Mar. 30, 2009, and to U.S. Provisional Patent Application No. 61/282,589, filed on Mar. 4, 2010 which are incorporated herein by reference.

### TECHNICAL FIELD

The present invention pertains to the functional and decorative field of illumination and more particularly to programmable, modular lighting systems for backlighting of objects, applications and method thereof.

### BACKGROUND OF THE INVENTION

This invention pertains to lighting systems, more particularly to back lighting systems, and yet more particularly it pertains to single or plurality of modular back lighting modules that are configured to resist environmental hazards, and may further include programs and communication means to form systems for functional and/or decorative applications.

This invention not only pertains to lighting modules that are environmentally resistant as a single module, but further include associated provisions that make the lighting system formed by the modules environmentally resistant. In order to make the lighting system(s) of the present invention more resistant to environmental hazards, for instance, the associated provisions are also environmentally resistant. The provisions are categorized into two classes, auxiliary components and fixtures as will be explored fully later.

The preferred light sources for the present invention consists of light emitting diodes (LEDs), organic light emitting diodes (OLEDs), electroluminescents (ELs) and LED edge-lit planar lightguides (LESs), individually or collectively hereby called light source (LS). It is understood that anywhere in this invention, LED, OLED, EL, LED edge-lit planar lightguides (LES) are interchangeable and or can be used individually or in combination. As is well known in the art, LED, OLED, EL and LES which are also individually or collectively referred to as solid-state lighting, present new opportunities to integrate lighting into systems in practical and durable manner. The added durability can permit the use for military, security, safety, industrial and other purposes. Several issues remain unresolved, however, by the new technologies. As an example, hot spots and dead zones, and dark junctions between modules, still compromise the effectiveness of illuminated modules. Weatherproofing of the LS of the modules from water and/or dirt among other environmental elements also remains impractical and rather costly.

The LS of the present invention are advantageously enclosed in environmentally resistant enclosures and possibly are further advantageously augmented by combining with environmentally resistant auxiliary components and fixtures, as will be explored later, and are hereby individually or collectively referred to ERLS (environmentally resistant light system).

In the decorative and functional backlighting applications, for the most part, each application must be designed and engineered for each specific application to render the system resistant to the environment. For instance, if OLED backlighting is used for relatively large surface areas (e.g., over 10 cm by 10 cm) and larger, the system becomes prohibitively expensive and impractical. If LED edge-lit lightguides are used, the systems are confined to small to moderate size areas (e.g., around 30 cm by 30 cm) because of the difficulty in providing an adequate number of LEDs along one or more edges. The modular design of the present invention overcomes these and other shortcomings, as will be explored later, allowing customizable sizes, shapes, colors, and textures while providing a low profile lighting system. For practical purposes, the modular design allows any shape or size assembly without custom engineering for each system.

If modules are used to create linear arrays or matrix arrangements and such, control and communication means can also be advantageously used to provide commands such as color changing and sequencing and the like among other programs. It is understood that the control and communication can be two ways (e.g., between, for example, a command and communication center and the modules of a system) or one way (e.g., commands sent from command and control center to modules of a system or from the modules of a system to the command and control center). It is understood that the commands to each ERLS can be provided by remote means (e.g., remotely located command and control center), or external means (e.g., command and control center within a system), or the means can be integrated within the ERLS as will be explored later.

Essentially, the systems of the present invention consist of different classes of devices:
The ERLS (Environmentally Resistant Light System): refers to the LS, for example, enclosed in an enclosure that renders the module resistant to certain environmental hazards such as hazardous chemical environments.
Control and Communication Means (CCM): are the class of devices which are to provide data for color changing, dimming, sequencing and/or other similar commands using embedded preprogrammed commands or virtual commands. The communication between the ERLS and the CM can be established by use of hard-wired connections or use of wireless devices.
ERLS Auxiliary Components: are components that augment the environmental resistance of the module; for example, an auxiliary component can include grommets and electric leads that secure the leads to the ERLS body.
ERLS Fixtures and Arrangements: such as frames, clips, fasteners and such that allow the modules of the system to be arranged in advantageous manners.

Some other factors that are important are, for example, the power source for the ERLS and the CCM that can be high or low voltage AC, although low voltage AC is preferred. Similarly, the power source can be high or low voltage DC, whereby low voltage DC is preferred. The power to the various components can be high-voltage, “hard-wired” or use low-voltage batteries to operate. It is understood that provisions can be made to allow the circuitry to switch from AC, hard-wired electricity to battery-operated DC. The battery can be integrated into the modules of the system and can be rechargeable as long as provisions are made to keep the ERLS and associated auxiliary components resistant to the harsh or hazardous environment.

The ERLS and the CCM devices may be installed using appropriate fasteners, frames, clips, etc. for concrete, drywall, wood panels and other interior or exterior surfaces for application such as architectural, signage, retail, pathway, stage, cove, cold-case food, retail, restaurant, casinos, etc. along walls, upper surfaces in corridors and hallways among others and will be explored in detail later.

It is understood that the applications of the systems of the present invention are not limited and the modules or systems can also be used, for example, for emergency lighting, passive lighting, baseboards, chair rails, crown moldings and the like in office complexes, multi-level parking structures, public libraries, hospitals, hotels, superstores, shopping malls, courtyards, oil-rig platforms among other venues. The modules or systems can also be used in vehicles such as passenger liners, sailboats, watercrafts, trains, buses, aircraft and such.

In other applications, for example, for night vision applications, infrared LEDs (e.g., LEDs emanating light in the 850 nanometer and higher) can be used to make the ERLS modules and/or systems detectable by night vision devices in military and security applications. Similarly, LEDs with frequencies in the ultraviolet range (e.g., LEDs emanating light in the 370 nanometer and lower) can be used to detect substances as well known in the art in, for example, industrial applications.

For simplicity and clarity of illustration, the drawing figures illustrate the general manner of construction, and descriptions and details of well-known features and techniques may be omitted to avoid unnecessarily obscuring of the drawings. Additionally, elements in the drawing figures are not necessarily drawn to scale. For example, the dimensions of some of the elements in the figures may be exaggerated relative to other elements to help improve understanding of different modules. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the modules of systems and methods for manufacturing the same described herein are, for example, capable of operation in sequences other than those illustrated or otherwise described herein. Furthermore, the terms “include,” and “have,” and any variations thereof, are intended to cover a non-exclusive inclusion, such that a process, method, system, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the modules of the systems and methods for manufacturing the same described herein are, for example, capable of operation in other orientations than those illustrated or otherwise described herein. The term “coupled,” as used herein, is defined as directly or indirectly connected in an electrical, physical, mechanical, optical, or other manner. The term “on,” as used herein, is defined as on, at, or otherwise adjacent to or next to or over.

The terms “couple,” “coupled,” “couples,” “coupling,” and the like should be broadly understood and refer to connecting two or more elements, mechanically, electrically, optically, and/or otherwise, either directly or indirectly through intervening elements. Coupling may be for any length of time, e.g., permanent or semi-permanent or only for an instant. The absence of the word “removably,” “removable,” and the like near the word “coupled,” and the like does not mean that the coupling, etc. in question is or is not removable.

The term “translucent” describes a material that is translucent and/or transparent.

### DESCRIPTION OF THE DRAWING

FIG. 1 illustrates a perspective view of a module constructed in accordance with the invention.

FIG. 2 illustrates a perspective exploded view of the module of FIG. 1.

FIG. 3 illustrates a side view of a lightguide coupled with light sources of the module of FIG. 1.

FIG. 4 illustrates a top view of light sources coupled to a lightguide comprising v-cut features.

FIG. 5 illustrates a top view of light sources coupled to a lightguide comprising dot-printed features

FIG. 6 illustrates a top view of light sources coupled to a lightguide comprising dot-etched features.

FIG. 7 illustrates a top view of light sources coupled to a lightguide comprising microlens, microprism, and/or microstructure features.

FIG. 8 illustrates an electrical schematic of circuitry for the one or more light sources of the module of FIG. 1.

FIG. 9 illustrates a perspective view of the module of FIG. 1 after being cropped.

FIG. 10 illustrates a top view of an arrangement of modules of FIG. 1 into a system, where the system comprises a grid.

FIG. 11 illustrates a side view of the system of FIG. 10.

FIG. 12 illustrates a top view of an arrangement of modules of FIG. 1 into a system without grids.

FIG. 12a illustrates a side view of the system of FIG. 12 with the frame shown.

FIG. 12b illustrates an exploded side view of one module and frame of the system of FIG. 12.

FIG. 13a illustrates a top view of the frame for an arrangement with outlines and socket locations for the placement of modules to form the arrangement.

FIG. 13b illustrates a top view of the FIG. 13a with number of sockets increased and socket locations rearranged.

FIG. 13c illustrates a top view of the frame along one outline of FIG. 13a cropped along a horizontal line.

FIG. 13d illustrates a side view of the frame of FIG. 13c.

FIG. 14 illustrates an exploded side view of one module and frame of a system with grommets installed onto the leads of the module.

FIG. 15 illustrates a schematic arrangement of modules installed in a linear array configuration on a building riser to form a system.

### DESCRIPTION OF THE PREFERRED MODULE

### Environmentally Resistant Lighting System

First, the environment resistance aspects of the modules of the present invention are explained in detail. An ERLS (environmentally resistant lighting system), essentially refers to any of solid-state lighting sources enclosed within an environmentally resistant enclosure with a first upper surface, a first lower surface and perimeter surfaces that in combination protect the light source (LS). The first upper surface and the first lower surface are coupled to the perimeter surfaces or walls. The first upper surface and the first lower surface are substantially opposite and located at the top and bottom. One or more light sources are enclosed within the enclosure to shine a light from the one or more light sources in a substantially uniform pattern towards the upper or lower and/or both surfaces. The light may shine from the perimeters as well. All surfaces may be transparent or partially translucent to permit at least part of the light from the one or more light sources to shine through any of the surfaces.

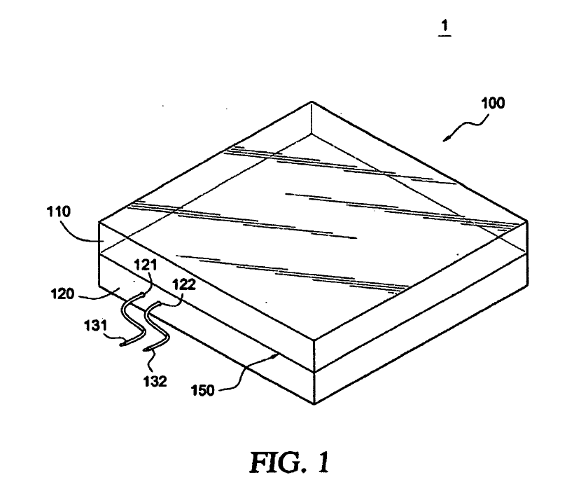

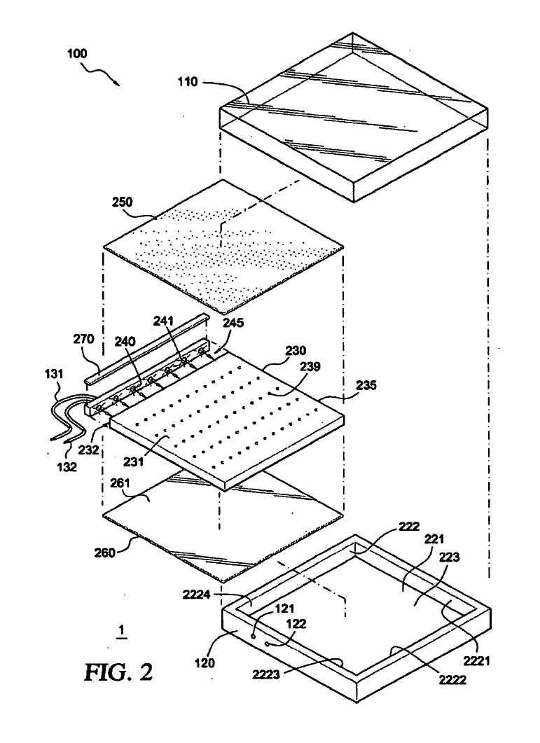

Referring now to the figures, FIG. 1 illustrates a perspective view of module 1. FIG. 2 illustrates a perspective exploded view of module 1. Module 1 comprises lower surface 120 and upper surface 110 coupled together at junctions 150 (FIG. 1).

As described in further detail below, module 1 comprises LS that emits light visible through upper surface 110, where upper surface 110 is transparent or at least partially translucent. As a result, module 1 can be visible even in dark conditions when turned on or otherwise energized. As seen in FIG. 2, module 1 comprises inside of lower surface 221 and one or more perimeter surfaces 222, 2221, 2222 and 2223 coupled to inside of lower surface 221. In the illustrated module, perimeter surfaces 222, 2221, 2222 and 2223 are located around the entire perimeter of lower surface 120, but other configurations are possible. Although in the present module lower surface 120 and perimeter surfaces 222, 2221, 2222 and 2223 are shown as formed out of the same piece of material, there could be other modules where lower surface 120 and perimeter surfaces 222, 2221, 2222 and 2223 are formed out of different pieces of material and then coupled together to form lower surface 120. In the present example, the perimeter of lower surface 120 is rectangular, but other configurations are possible. Similarly, in the present example, perimeter surfaces 222, 2221, 2222 and 2223 illustrate a rectangle, but other configurations are possible. For example, in a different module, one or more perimeter surfaces 222, 2221, 2222 and 2223 could comprise a single wall forming a circular or oval closed perimeter around a circular or oval lower surface.

With respect to the environmental resistant aspect, the enclosed module 1 can be categorized according to standards as defined in the protection of enclosures against ingress of dirt or against the ingress of water and/or other fluids as defined by International Protection Code like in IEC529 (BSEN60529:1991). Conversely, an enclosure which protects the LS against ingress of particles will also protect a person from potential hazards within that enclosure, and this degree of protection is also defined as standard in IEC529 (BSEN60529:1991).

For the purposes of the present invention, the degrees of protection as defined in IEC529 (BSEN60529:1991) are most commonly expressed as “IP” followed by two numbers (e.g., IP 67), where the numbers define the degree of protection. The first digit (referring to “Foreign Bodies Protection”) indicates the extent to which the LS are protected against elements in the environment. The second digit referring to “Water Protection” and indicates the extent of protection against water as well known in the art. For example, the first number, 6, in the IP number above indicates complete protection against the intrusion of dust and the second number, 7, indicates resistance or the capability to withstand temporary immersion in a tank, to the depth of 15 cm to 1 m as disclosed therein in IEC529 (BSEN60529:1991). Altogether, complying with the standards as disclosed make the enclosed system in module 1 to be resistant to intrusion of solids, liquids and protection against tools or other object impact as disclosed therein.

Similarly, there are many NEMA (The National Electrical Manufacturers Association) ratings available for enclosures. For example, NEMA 3 discloses enclosures that are intended for general purpose outdoor use primarily to provide a degree of protection against windblown dust, rain, and sleet; and to be undamaged by the formation of ice on the enclosure. Or NEMA 6 discloses enclosures that are intended for general purpose indoor or outdoor use primarily to provide a degree of protection against the entry of water during temporary submersion at a limited depth; and to be undamaged by the formation of ice on the enclosure. The lighting modules of the present invention are intended to comply with the range of minimum and maximum rating according to the IP or NEMA standards as herein intended. The range includes NEMA 1 to NEMA 7 (e.g., Underwriters Class 1—Groups C&D—Explosion Proof—Indoors), which are intended for indoor use in locations classified as Class I, Groups A, B, C, or D, as defined in the National Electrical Code, or NEMA 9 (e.g., Underwriters Laboratories Class II—Groups E, F, G—Indoors), which are intended for special purpose, classified as hazardous, which refers to enclosures including, among resistance to other environmental factors, such as to heat generating devices that shall not cause external surfaces to reach temperatures capable of igniting or discoloring dust on the enclosure or igniting dust-air mixtures in the surrounding atmosphere. Enclosures shall also meet dust penetration and temperature design tests, and aging of gaskets, if used, and the like.

Of course, the modules of the present invention may also comply with NEMA 10 to meet the standards set by Bureau of Mines; or, NEMA 11 (e.g., Corrosion Resistant & Drip Proof—Oil Immersed—Indoors); NEMA 12 for industrial use; or NEMA 13 for industrial indoor use primarily to provide a degree of protection against dust, spraying of water, oil, and noncorrosive coolants.

Another aspect of the present ERLS refers to fire and flame retardancy of the modules of the present invention. There are several ways in which the fire and/or flame retardancy of the enclosure can be affected. This can be by inclusion of fire retardants in the enclosure. For example, one commonly used fire retardant that can be applied in coating form is aluminum hydroxide. Aluminum hydroxide, when heated, dehydrates to form aluminum oxide (alumina, Al₂O₃) and releasing water vapor in the process. This reaction absorbs a great deal of heat, cooling the material over which it is coated. Additionally, the residue of alumina forms a protective layer on the material's surface. This coating however retards the transparency of the enclosure of the present invention by blocking the light and may need to be selectively applied depending on the application. Another class of materials that can be used as a fire and/or flame retardant forms a char as a barrier, well known in the art, as a layer that is much harder to burn and prevents further burning. Another class of materials that can be included is intumescents that upon heating cause swelling of the barrier behind the protective char layer, providing much better insulation behind the protective barrier.

There are many other variation of materials that can be included in the enclosures for practicing the present invention and are well known in the art such as, organic halides (haloalkanes) such as Halon and PhostrEx and such. These and other forms of fire retardants are classified by National Fire Protection Association (NFPA), the Fire Retardant Forum or European Fire Retardant Association. It is noted that similar to classification of enclosures according to “IP” and NEMA codes, the range of fire retardants applicable to the present invention is wide and the minimum and maximum range of fire retardancy are contemplated herein.

Another aspect of the present ERLS refers to the degradation of the materials of the enclosure and/or the LS upon exposure to the environment and/or hazardous conditions. For example, if polycarbonate is used as a lightguide and not protected or as an enclosure material without appropriate precautions, then as the polycarbonate is susceptible to moisture, yellowing upon exposure to ultraviolet light and hazing would sustain damage as is well known in the art. On the other hand, polycarbonate offers impact resistance, which may be a desired property in some applications. Again to make the modules of the present invention suitable for many applications (i.e., to increase the life of the modules and maintain maximum light output among other desirable properties), it is contemplated that materials are selected in an optimized manner to render the module both functional and resistant to the environment. For example CALIBRE™ 300-10 polycarbonate resin, according to the manufacturer, DOW Plastics of Midland, Mich., USA, offers exceptional impact resistance, heat distortion resistance, and optical clarity, includes UV stabilizer, and meets Underwriters Laboratory and Canadian Standards Association (CSA) approvals; nonetheless, it does not provide resistance to certain frequencies that CALIBRE™ MEGARAD™ 2081-15 does. CALIBRE™ MEGARAD™ 2081-15 also manufactured by DOW Plastics of Midland, Mich., USA, also offers water-clarity look of the natural resin.

In yet another aspect of the present invention, the anti-fungi or anti-static properties of the enclosure may be of interest. For example, some fluoropolymers offer exceptional resistance to the harsh chemical environments, but are notoriously static and easily gather dust that limits the light output of the modules of the present invention. Or polybutyrates offer ease of manufacturing and are water clear, but are susceptible to fungi growth.

It is evident that the materials of construction of the enclosure and other components of the modules of the present invention must advantageously be optimized and utilized in an appropriate manner. One skilled in the art appreciates that the range of materials, the range and extent of resistance to the environment and standards, the range and extent of hazardous conditions and standards and such other properties are wide and extensive and one skilled in the art would consider the minimum to maximum range first and select the appropriate range to comply with the invention as is contemplated herein.

Referring back to FIG. 2, the lower surface 120 can comprise a polycarbonate such as CALIBRE™ MEGARAD™ 2081-15, as described above for upper surface 110. In a different example, lower surface 120 can comprise a metallic material, such as aluminum or any of the materials described above for upper surface 110.

Another example of upper surface 110 could use a polymethyl methacrylate material such as DF100, from Atofina Chemicals, Inc. of Philadelphia, Pa., USA. Although normally transparent, the polymethyl methacrylate material could also be pigmented if desired. In other examples, upper surface 110 can comprise a different polymeric material, such as a polyester, polyamide, polycarbonate, high impact polystyrene, polyvinyl chloride (PVC), and/or acrylonitrile butadiene styrene (ABS) material, among others. Still other upper surface 110 of modules can comprise a glass material that is at least partially translucent and can withstand high temperature and corrosive chemicals

As explained before, it is the intent of the present invention to use modules to form a system or arrangement that has at least a surface area larger than the surface area of one module according to the present invention. For example, system 1 can comprise other modules that can be similar and/or identical to ERLS 100, such that the modules of system 1 can be arranged relative to each other in multiple configurations for a variety of applications. One application of lighted system 1 can be for functional purposes. For example, the modules of a system can be arranged relative to each other as an illuminated matrix forming a backlighting for use in bus stations. In the same or a different example the modules of a system may be configured to statically illuminate with one or more colors of light, and/or to dynamically alternate one or more colors of light. In the same or a different example, the modules of a system may comprise a controller mechanism responsive to a command and control center, such as a computer and the associated programs embedded therein, to control the modules of a system through different layout or timing patterns, where the different layout or timing patterns could be responsive to user input (instant programming), responsive to environmental conditions (i.e. ambient light intensity, ambient temperature, etc.), lights incoming (i.e., headlight of a vehicle), sounds, and/or music in some instances as well known in the art.

Another application of a system of the present invention may be, for example) for safety purposes in an industrial area where the backlit area is extremely slippery. In this instance, for examples, the modules of a system may have a non-slippery surface formed by indentations and such and constructed of materials selected to withstand harsh liquids such as motor oil in or around garage floors, factory hallways, walkways, and/or stairs. Such illumination could reduce the risk of accidents by making hazardous objects visible and/or by leading people to entrances or exits

Referring back to FIG. 2, the ERLS 100 also comprises lightguide 230 located between surface 221 of lower surface 120 and upper surface 10. Lightguide 230 can comprise dimensions corresponding to dimensions of cavity 223 of lower surface 120, such that lightguide 230 can be located within lower surface 120. In a different module, lightguide 230 may form part of, or be integral with, surface 221 of lower surface 120 or upper surface 110. ERLS 100 also comprises one or more light sources 240 coupled to lightguide 230. Light sources 240 are demonstrated as LEDs in the present module, but could comprise of other devices such as OLEDs and/or EL in alternative modules.

Upper surface 110 can be coupled to walls 222 of lower surface 120 and can be located substantially opposite lower surface 221 to seal lightguide 230 and light sources 240 within cavity 223 via a junction such as junction 150 (FIG. 1), where the junction can comprise a an adhesive junction, whereby the adhesive can also withstand the harsh environment that the module is exposed to. In one examples, a junction could comprise a material such as LORD® 3170-A/3170-B manufactured by LORD Corporation of Erie, Pa., USA, which is a two-component, modified epoxy structural adhesive system for extremely cold environments. In the same or a different module, an adhesive junction could comprise a silicone material and/or other polymeric materials such as LORD 7610EZ Urethane Sealant/Adhesive manufactured by LORD Corporation of Erie, Pa., which is a single-component, moisture-cure urethane adhesive offering excellent adhesion in a wide range of temperature. The junction can be weatherproof and/or waterproof to restrict water and/or dirt from entering cavity 230 of lower surface 120 and to thereby protect lightguide 230 and light sources 240 from the elements. In some modules, ultrasound welding can be used to join the upper and lower surface. Likewise, in some examples, ultrasound may be used for joining lower surface 221 and walls 222 of lower surface 120.

In the present example, lightguide 230 comprises planar lightguide 235, and light sources 240 are distributed across circuit board 241. Circuit board 241 is configured to fit between wall 2224 of lower surface 120 and edge 232 of lightguide 230 when circuit board 241 and lightguide 230 are located in cavity 223 of lower surface 120. Leads 131-132 are also coupled to light sources 240, and are configured to provide a path for power to reach light sources 240. When circuit board 241 is located in lower surface 120, leads 131-132 can be routed through electric leads 121-122 to be accessible at an exterior of the module. Although in the present example electric leads 121-122 are shown coupled through wall 2223 of lower surface 120, there could be other modules where electric leads 121-122 are routed to the exterior of ERLS 100 through other locations. In the present example, when circuit board 241 is between wall 2224 and lightguide 230, light sources 240 are located substantially parallel to edge 232 of lightguide 230. As a result, light sources 240 can shine light 245 from one or more light sources 240 through edge 232 into lightguide 230.

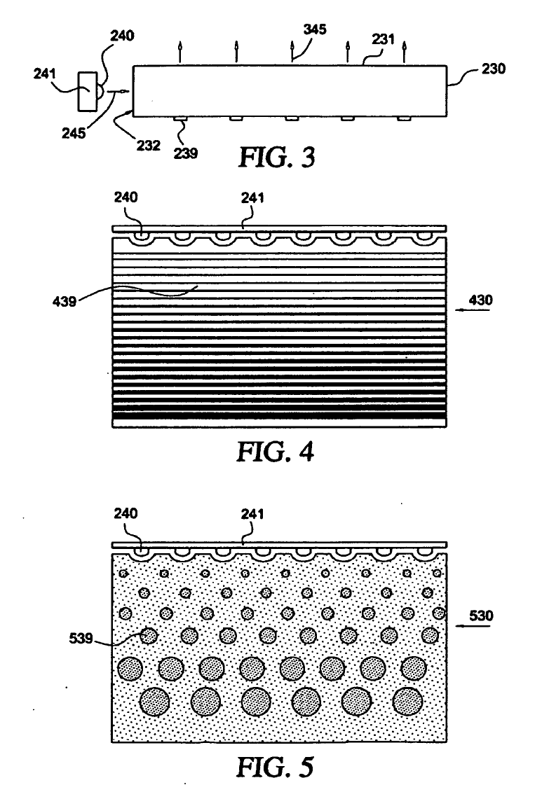

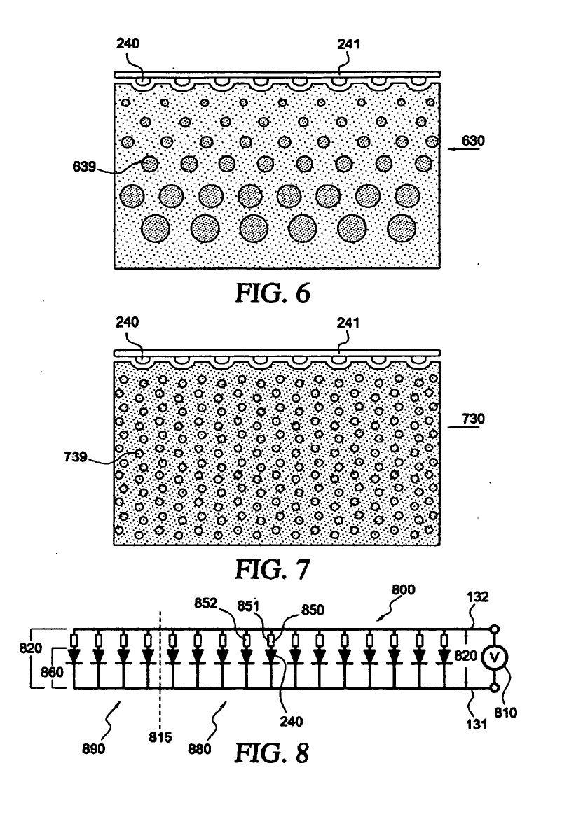

FIG. 3 illustrates a side view of lightguide 230 coupled to one or more light sources 240 of ERLS 100. Lightguide 230 comprises features 239 configured to direct at least portion 345 of light 245 towards and/or through side 231 of lightguide 230. In the present example, features 239 are substantially evenly distributed across lightguide 230, and can also shine portion 345 of light 245 in a substantially uniform pattern towards upper surface 110. In other modules, lightguide 230 can comprise features different from features 239 to direct light towards upper surface 110 (FIGS. 1 and 2) in a substantially uniform pattern. As an example, FIG. 4 illustrates a top view of lightguide 430 comprising v-cut light guide features 439, and FIG. 5 illustrates a top view of lightguide 530 comprising dot-printed features 539. As further examples, FIG. 6 illustrates a top view of lightguide 630 comprising dot-etched features 639, and FIG. 7 illustrates a top view of lightguide 730 comprising microlens, microprism, and/or microstructure features 739.

In some examples, the features of lightguide 230 of ERLS 100, such as features 239 (FIGS. 2 and 3), 439 (FIG. 4), 539 (FIG. 5), 639 (FIG. 6), and/or 739 (FIG. 7), can be capable of shining a portion of light 245 in a substantially uniform pattern towards upper surface 110 (FIGS. 1 and 2) even if the features themselves are not substantially evenly distributed across their respective lightguides or differ in size and/or concentration. In any event, because upper surface 110 is partially translucent, it can permit at least portion 345 of light 245 to shine through upper surface 110 (FIGS. 1 and 2) and to escape from an exterior of ERLS 100 to backlight an object as contemplated by the present invention.

Returning to FIG. 2, ERLS 100 further comprises diffusive layer 250 located between side 231 of lightguide 230 and upper surface 110. In the present example, diffusive layer 250 is configured to diffuse light directed towards upper surface 110. For example, diffusive layer 250 can be translucent, partially transparent, and/or frosted to diffuse portion 345 of light 245 evenly across upper surface 110. Other modules may eliminate the use of diffusive layer 250, particularly when lightguide 230 serves the same or similar function as diffusive layer 250.

The ERLS 100 also comprises reflective layer 260 in the present module, where reflective layer 260 comprises reflective sheet 261 located between lightguide 230 and lower surface 221 of lower surface 120. Reflective layer 260 can be configured to reflect at least a portion of light 245 that shines through side 232 of lightguide 230 back towards upper surface 110. In a different module, reflective layer 260 can be eliminated, particularly where lower surface 221 serves the same function of reflective layer 260. Other examples may also forego the use of reflective layer 260.

Continuing with the module of FIG. 2, ERLS 100 also comprises hot spot blocking mechanism 270 positioned between upper surface 100 and at least a portion of light sources 240. Hot spot blocking mechanism 270 also can be located between diffusive layer 250 (when used) and circuit board 241. Hot spot blocking mechanism 270 is opaque, and can thus be used to block or diminish the appearance of “hot spots” or concentrations of light around the one or more light sources 240 in order to aid in the uniform distribution of light 245 towards upper surface 110. In the present example, hot spot blocking mechanism comprises a strip of metallic foil, although other materials such as an opaque plastic are possible. Other examples may forego the use of hot spot blocking mechanism 270.

FIG. 8 illustrates an electrical schematic of circuitry 800 for one or more light sources 240 of ERLS 100 (FIGS. 1-2). Circuitry 800 can comprise power supply circuit 810 to power at least a portion of one or more light sources 240. In the present example, power supply circuit 810 couples to light sources 240 through leads 131-132 to supply rated power magnitude 820 of approximately 12 Volts DC (direct current). Although light sources 240 are rated to handle at least approximately 12 Volts DC in the present module, other modules may comprise light sources configured to handle a different rated power magnitude, such as approximately 3 Volts DC.

The present module may also comprise derating circuit 850 configured to deliver a derated power magnitude 860 to one or more light sources 240, where derated power magnitude 860 is less than rated power magnitude 820. In the present example, derating circuit 850 comprises resistance elements coupled between a node of lead 132 and each of light sources 240 to generate derated power magnitude 860. Each one of one or more light sources 240 is thus coupled to a different one of the one or more resistance elements of derating circuit 850 in the present example. As an example, the one or more resistance elements can comprise resistors 851-852, but other resistance elements can be used. Resistance values for the resistance elements may be tailored depending on, for example, a target lifetime for light sources 240, the output of power supply circuit 810, and/or on the type or brand of light sources 240. By providing light sources 240 with derated power magnitude 860, instead of rated power magnitude 820, the longevity of light sources 240 can be increased accordingly.

In a different module, derating circuit 850 comprises a different configuration. As an example, derating circuit 850 can comprise a single resistance element, instead of a set of resistance elements. In this example, the single resistance element can be located between power supply circuit 810 and each of light sources 240, and/or between lead 132 and each of light sources 240. This example can be used when light sources 240 are located closer together to each other and/or when there are fewer light sources 240, particularly when the power source for the lighted tile system is a DC power source, and the module of FIG. 8 can be used when light sources 240 are located further apart from each other and/or when there are a larger quantity of light sources 240. If the power source is an alternating current (AC) power source, however, the choice of which module of derating circuit 850 to use can be based on other considerations such as, for example, cost. Other aspects of circuit 800 shown in FIG. 8 are described below.

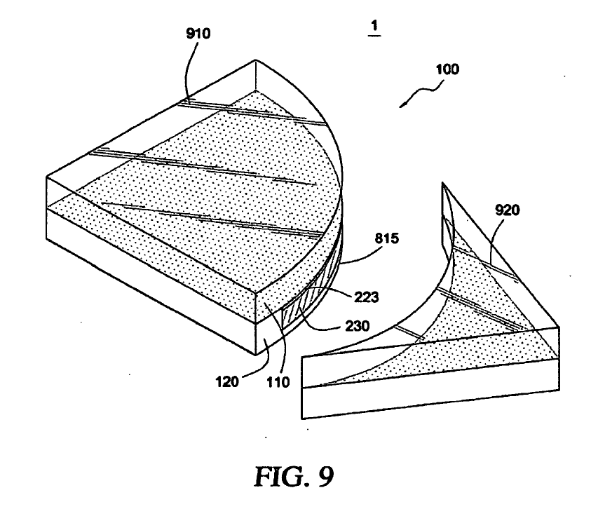

FIG. 9 illustrates a perspective view of ERLS 100 after being cropped. In the present module, ERLS 100 is comprised of materials crop-able to form a custom edge, such as custom edge 815 of section 910 of ERLS 100. The ability to crop custom edge 815 of ERLS 100 can be beneficial, for example, to permit section 910 of ERLS 100 to be positioned within a defined perimeter. The ability to crop custom edge 815 can also permit section 910 of ERLS 100 to conform to a specific contour of an area over which section 910 is to be laid, without having to manufacture custom ERLS having a myriad of custom sizes.

In the present example, section 920 of ERLS 100 is cropped off of ERLS 100 by sawing or otherwise cutting along custom edge 815. The cropping of a custom edge can, as in the present example, leave exposed the contents of cavity 223, including lightguide 230 and light sources 240, such that ERLS 100 would no longer be environmentally resistant (i.e., weatherproof) and/or waterproof to protect the contents of cavity 223. To remedy the exposure of cavity 223 after cropping ERLS 100, custom edge 815 can be configured to be in a manner such that the environmental resistance characteristics of the original module according to the present invention is maintained and/or restored. For example, the adhesive used for the replacement or repair of wall section, to make the module withstand high temperatures may be LORD® 3170-A/3170-B as disclosed before.

One benefit of the present example is that light sources 240 are configured to remain operable after the cropping of ERLS 100. Returning to FIG. 8, the one or more light sources 240 are interconnected such that at least portion 880 of light sources 240 coupled to section 910 of ERLS 100 (FIG. 9) will survive such cropping. In the present example, the parallel nature of circuitry 800 permits portion 880 of light sources 240 to remain operational even though the cropping through custom edge 815 splits portion 890 off of circuitry 800. The different module of FIG. 8 where derating circuit 850 comprises a single resistor, as described above, also can be cropped in this manner.

### Control and Communication Means

The second class of component of the present invention is the control and communication means (CCM). CCM, for the purposes of the present invention, are categorized into two types: one is control means and two is communication means. Controls refer to circuitry and programs that, for example, affect color changing, dimming, switching and the like. Communication means refers to the means for transmitting commands to the modules and/or system, and/or receiving environmental changes sensed from the modules, system or other associated devices and such.

Control means such as embedded, preprogrammed circuitry, for solid-state lighting systems according to the present invention, for example, to change color of light, to dim the light and the like are well known in the art. However, for the purposes of the present invention, if these circuits are embedded within the enclosures, then such circuits must also withstand the harsh environments as disclosed herein. For example, X-CHIP-300 PRO, one of the X-CHIP series offered by Lighting Effects Distribution Ltd. of Kent, United Kingdom complies with IP 67, and can be used according to the present invention, provided that it is enclosed within an enclosure of the present invention that also complies with IP 67. The X-CHIP-300 PRO is configured to work with standard DMX-512A protocol for color changing. The standard DMX-512A protocol is well known in the art.

In another system, the control unit may be installed externally to one module or series of modules that form a system. In such an instance, a control unit such as PDS-742-IP 67 Programmable Device Server provided by ICP DAS USA, Inc. of Harbor City, Calif., USA which has a “special design for the toughest applications” according to the manufacturer can be used. The PDS-742-IP67 also includes IP 67 connectors rated to protect against water, oil, dust, vibration, and more. It is understood that, although, the example above, indicates that both the module, system and control, comply with IP 67 requirements; in other instances, the module and system may have one rating (i.e., IP 67), while the control, that is installed externally, may have a different rating (i.e., IP 65, which is a lower rating or IP 69, which is a higher rating) without deviating from the present invention.

Yet, the control unit can be remotely located according to the present invention and the commands relayed via wired or wirelessly. For example, control unit PDS-742-IP 67 Programmable Device Server can be remotely installed as a control unit. The commands can be provided to the system via wire or if wireless communication is desired, then through an appropriate interface as will be explained in detail later. It is understood that, although the example above, indicates that both the module, system and control, comply with IP 67 requirements; in other instances, the module and system may have one rating (i.e., IP 67), while the control, that is installed remotely, may have a different rating (i.e., IP 65, which is a lower rating or IP 69, which is a higher rating) without deviating from the present invention.

One skilled in the art can select appropriates ERLS and controls to serve in any harsh environment. For example, in the transportation industry and more particularly in the air transportation industry, the modules and/or systems of the present invention can be used in airport runway lighting to change color of light or intensify the light to a relatively higher output depending on the environmental changes such as heavy fog or such to assist airport personnel. In such corrosive salty environment of the airport runway lighting, the ERLS must be configured to meet the US Military Standard Salt Fog Test standards to comply with MIL-STD-810E, Method 509.3, Procedure I. One skilled in the art may use appropriate enclosure material to protect the LS such as fluoropolymers and use controls that meet the same or higher standards. For another hazardous location such as petrochemical facilities, the modules or system of the present invention and the control must comply with Class 1, Division 2, Groups ABCD Hazardous, T5 rated as required by the standard.

With reference to the second type of control and communications means, the communication means, according to the present invention may be one or two way means. For example, in addition to the LS and control, at least one transmitter (e.g., communication means or device) may also be embedded within an enclosure to communicate the environmental changes detected by a sensor to the command and control center (CCC). If the communication mean is a one-way communication device, then the transmitted data will not receive a response from the CCC. Similarly, the CCC may only transmit commands to the modules of a system, if the CCC is configured to be a one-way transmitter only, as is well known in the art. However, if the communication mean is configured to be two-way, then a response may be received from the CCC according to the data received. For example, if the data transmitted is a rise in temperature, then the CCC may respond by sending commands to adjust the current (e.g., increasing the current in response to the increase in ambient temperature as the light output intensity of LEDs decrease with rise in ambient temperature) to the LS to maintain the same light intensity, in this manner a two-way communication is established.

The detailed construction, configuration and constitution and other attributes of communication means such as embedded communication means to relay commands are well known in the art. However, for the purposes of the present invention, if these communication means are embedded within the enclosures of the present invention, then the communication means must withstand the harsh environment as disclosed herein. In another system, the communication means may be installed externally to a system. For example, ImproX Weatherproof SupaGate Plus (product code SGI914-1-1-GB) Distributed by Amano Security Systems of Palm Harbor, Fla., USA has a weatherproof enclosure that complies with IP 66 and can be installed external and separate from a system of the present invention.

The ImproX Weatherproof SupaGate Plus also includes IP 66 connectors. It is understood that, although the example above, indicates that both the module, system and the communication means comply with IP 66 requirements; in other instances, the module and system may have one rating (i.e., IP 67), while the communication means, that is installed externally, may have a different rating (i.e., IP 60, which is a lower rating or IP 69, which is a higher rating) without deviating from the present invention.

Similarly, like the control means, the communication means can be remotely located according to the present invention and the communication established via wire or wirelessly. If wireless communication is desired, various standards and protocols related to infrared and radio frequency can be used. And if wireless communication network is desired, then the standards and protocols may include, Wi-Fi (e.g., a wireless local area network (LAN) technology), wireless local area networks (WLAN), low rate WPAN such as ZigBee (IEEE 802.15.4 protocol), Bluetooth (i.e., creating personal area networks (PANs)) among other standards and protocols well known in the art.

Another part of the communication means are appropriate interfaces for the systems of the present invention. Interfaces are devices, programs and standards that establish the communication between the modules and/or systems of the present invention to processing means such as a security computer and programs in a facility such as an airport, or a high rise building structure and such.

One skilled in the art can select appropriates ERLS and communication equipment and devices, communication protocols and standards, communication interface equipment and protocols, communication operating and dedicated programs for the implementation of the present invention.

### Auxiliary Components

Auxiliary components according to the present invention refers to components, aside from the module enclosures and communication means such as grommets, wires, socket, plugs, jacks, connectors among other components that may be used in harsh environments such as underwater, industrial and hazardous environments among other environments.

For example, to supply power to the modules of the present invention, electric leads have to be used. As such, if the enclosure is configured to comply with IP 67 rating, then the power lead wires and the grommets must at least comply with IP 67 rating. Such grommets and leads that meet environmental standards are offered by Amerline Enterprises Co. of Schiller Park, Ill., USA. Other examples of such auxiliary components include, IP 67 Protection Rated Rubber Grommets GR67 series offered by Alliance Plastics West of Santa Fe Springs, Calif., USA or Richco RG-Rubber Continuous Grommet series offered by CableOrganizer.com, Inc. of Fort Lauderdale, Fla., USA. Examples of wire and plugs include ControlPower Cordset part number MN654AC01M010 offered by Amphonel of Clinton Township, Mich., USA with temperature range of −20 C to +105 C, oil resistant PVC jacketing and rated according to IP 68 and NEMA 6P or J Power Series Taper Nose Single Pole In Line Latching Cam type connectors offered by Duraline Islandia, N.Y., USA with NEMA 3R and 1999 NEC requirements rating.

Connector examples include, Waterproof Circular Plastic Connector offered by SOURIAU Connection Technologies of York, Pa., USA with rating of Dynamic IP 68/IP 69, or waterproof connectors in mated or unmated conditions for military applications rated to MIL-DTL-26482 or equivalents such as BS 9522 FOO17, NFC93422, HE301B, VG 95328, or Dome Cap™ Cable Glands manufactured by Remke Industries of Wheeling, Ill., USA, suitable for corrosive and industrial applications exceeding NEMA 6 specifications and rated to IP 68 making them suitable for use underwater to 300 feet.

Another type of connector that can be used for the communication devices of the present invention are such connectors as radio frequency (RF), flange mount for use in military applications where environmental conditions require an extremely rugged and reliable hermetic seal as offered by PA&E of Wenatchee, Wash., USA which according to the manufacturer “provide excellent electrical and environmental performance characteristics”.

It is also noted that in some instances, very simple and inexpensive components such as 3M™ Scotchlok™ Connector series offered by Communication Markets Division, 3M Tele-communications of Austin, Tex., USA can be used. These connectors which are rated to be moisture resistant and fire retardant, and are easily handled and installed in use of modules and/or systems according to the present invention.

### Fixtures and Arrangements

One important aspect of the present invention pertains to modular character of the lighting modules that can be positioned adjacent to each other to form linear array(s) or arrayed to form contiguous surface(s) larger than at least one single module. Environmentally resistant aspects of one module and/or a system, communication means and auxiliary components according to the present invention were disclosed in previous sections. In this section, fixtures and arrangements that make the use and installations of modules and/or systems advantageously easier and environmentally resistant are disclosed. It is understood that the arrangements may be made in many different sizes, shapes, colors, etc. and arrayed into many combinations of shapes and sizes.

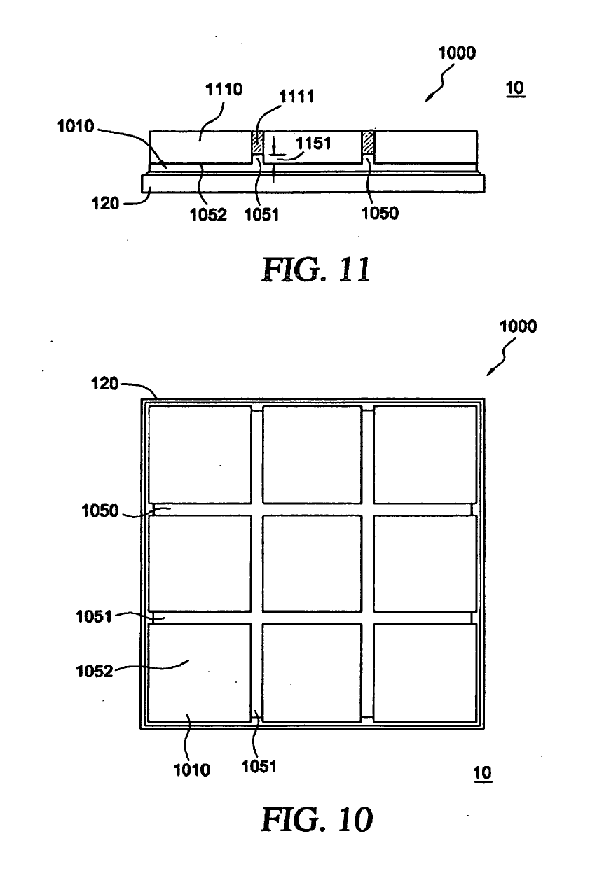

FIG. 10 illustrates a top view of plurality of ERLS 1010 modules or system 10, comprising a squared pattern grid 1050. FIG. 11 illustrates a side view of plurality of ERLS 1010 modules of system 10 with an appropriate material 1110, if used, such as an environmentally resistant adhesive (i.e., to comply with requirements of IP 67), located within the grid 1050. Grid 1050 comprises one or more regions 1051 and 1052 between one or more ERLS 1010 modules as part of system 10. Although the present example illustrates one or more regions 1050, 1051 and 1052 and one or more ERLS 1010 modules substantially rectangular or square in shape and as comprising a single size, there may be other modules where regions 1050, 1051 and 1052 and/or ERLS 1010 modules could comprise other or diverse geometric shapes.

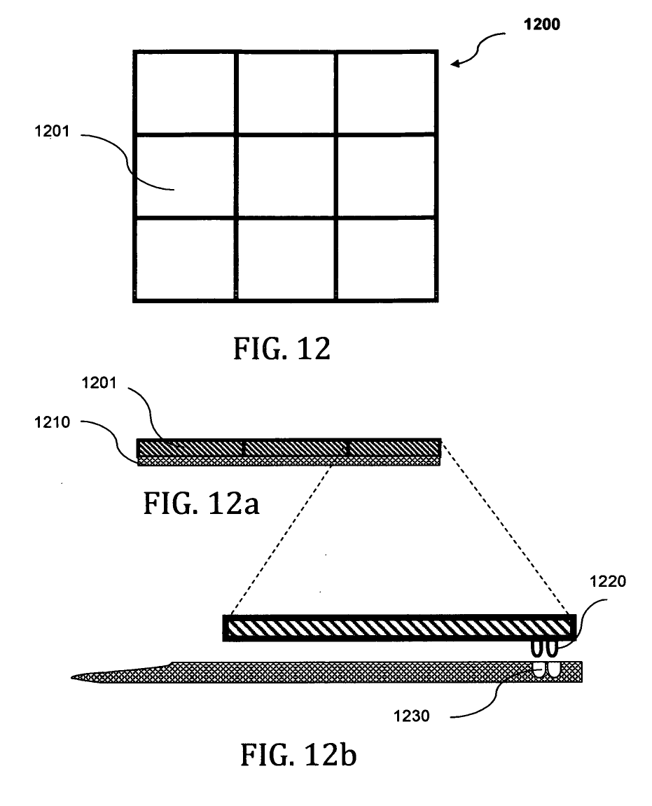

Continuing with the figures, FIG. 12 illustrates a system (arrayed into arrangement 1200) comprising a plurality of ERLS 1201 modules closely positioned adjacent to each other above frame 1210 (not visible) to form an arrayed arrangement 1200. FIG. 12a is side view of FIG. 12 with frame 1210 illustrated. Frame 1210 receives power from a power supply (not shown). Each ERLS 1201 module has a plug-like mechanism, plug 1220, protruded from ERLS 1201 module (FIG. 12b) to receive power and/or commands from the socket-like mechanism, socket 1230, of frame 1210 and a CCC, if communication is desired and if communication is established via wire. The plug 1220 is electrically connected to light sources 240 within the module (not shown).

In practice, the frame 1210 is advantageously configured to mount onto a vertical, horizontal and/or any other angle surface adaptable to receive at least one or preferably a plurality of ERLS 1201. Frame 1210 may also be flexible and wrap around an edge. The frame 1210, construction of which is explained later, may include means to attach to surfaces, such as, metal, concrete, ceramic, etc. In one system, such as illustrated in FIG. 12b, the ERLS 1201 modules are placed on top of the frame in such a manner that plugs 1220 and sockets 1230 are aligned, and when ERLS 1201 module are pushed the ERLS 1201 module attach to the frame, for example, by friction between the plug 1220 and socket 1230. It is noted that sockets 1230 of frame 1201 are pre-designed in a manner that the once the plugs 1220 and sockets 1230 are mated the desired backlighting surface-shape according to the present invention is obtained.

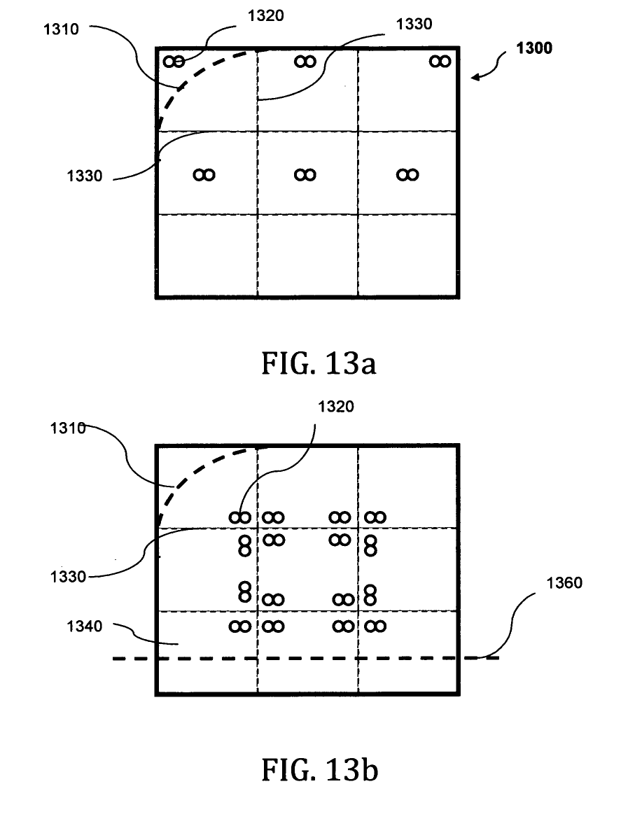

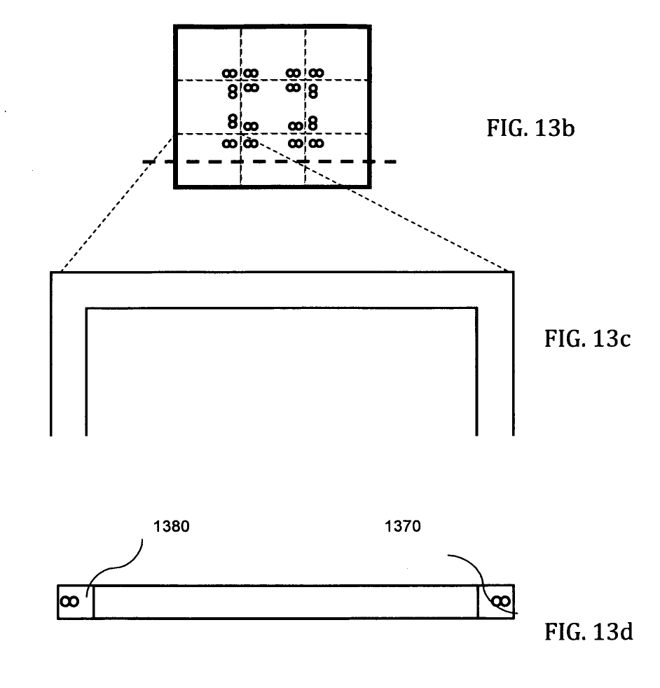

The frame 1210 of the system 1200, according to the present invention must at least include:
1. Appropriate electrical design to supply power to the plurality of ERLS 1201 modules. In one design, the circuitry must supply adequate DC power to each ERLS 1201 module. As it is well known in the art, DC power degrades rapidly with distance and with the size of the lead. Therefore, the electrical design must consider proper wire gauge, power bus design (i.e., parallel-serial configuration), power amplification, constant current regulation and other provisions to supply adequate and equal power to each module as is well known in the art.
2. Physical construction to support the pressure exerted by a plurality of ERLS 1201 module according to the present invention.
3. Comply with standards according to the present invention. For example, if a system according to IP 67 standards is desired, the frame must also meet the same standards.
4. Crop-able according to the present invention since one of the important aspects of the present invention is that the ERLS modules are crop-able to create different arrangements for in any shape; therefore, it is important that the frame also be configured to be crop-able. In doing so, one would appreciate that if the sockets 1230 are placed in the wrong location, then no power can be supplied and/or no communication can be established between the frame and the ERLS. FIGS. 13a and 13b illustrate this aspect.

FIG. 13a illustrates a frame such as used in the system of FIG. 12. The dashed lines are the outline of where the ERLS module would be placed. If one assumes that the system must eventually be cropped along line 1310, then it can be seen that socket 1320 of the frame 1300 would be cropped off and no power and/or commands would reach the ERLS module that is to be placed over outline 1330. Alternatively, FIG. 13b illustrates the proper placement of sockets 1320 for the system of FIG. 12, whereby if the frame is cropped along line 1310, then it can be seen that socket 1320 of the frame 1300 would not be cropped off and power and/or commands would reach the ERLS module that is to be placed over outline 1330.

One of the important aspects of the present invention is to create systems that can withstand harsh environments. Accordingly, provisions must be made if frame 1300 is cropped to create surface areas other than perfect squares or rectangles and to withstand, for example, intrusion of water or dirt. Such an intrusion can adversely affect the function of the system according to the present invention. Referring to FIG. 13b again, the outlines 1330 may actually be a narrow, hollow tubular conduits. Referring to FIG. 13b, the frame 1300 is cropped along line 1360 to illustrate how frame 1300 will be isolated from water or dirt. FIG. 13b is reproduced above FIG. 13c for clarity of discussion. FIG. 13c is the top view of square 1340 (FIG. 13b), cropped along line 1360 and expanded for better view. FIG. 13d similarly is a side view of the same portion of the frame 1300 expanded for better view. In FIG. 13d, two power leads 1370 are seen in squares 1380. It is now easily seen how the ends of cropped off outlines 1330 can be protected, for example, by the use of appropriate caps to seal off the leads and the hollow tubular conduit from the harsh environment and comply with standards as desired.

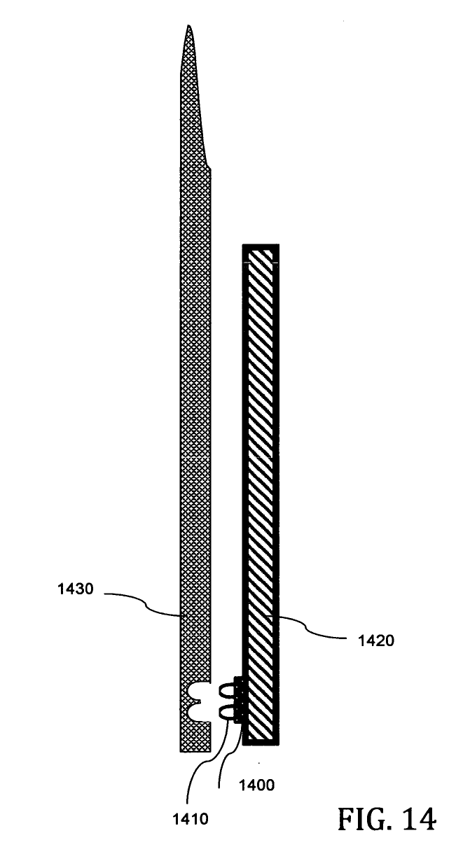

In yet another important aspect of the present invention, it may be desirable to avoid intrusion of water or dirt at the plug and socket connection. Referring to FIG. 14, grommets 1400 are placed on plugs 1410 in order to avoid intrusion of water and dirt as the module 1420 and frame 1430 are mated to comply with standards as desired.

### EXAMPLES

### Example 1

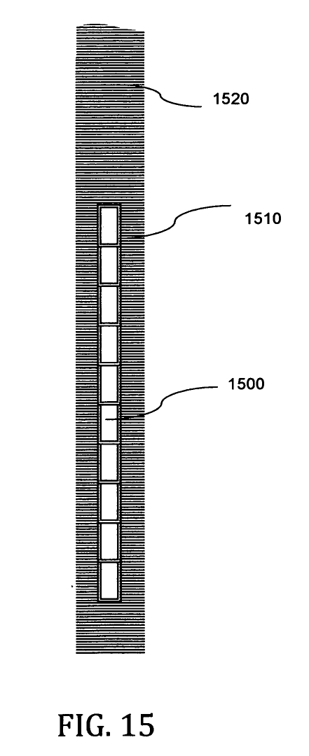

In one example of the present invention, a system can be configured and applied to the surface of risers of a building. For example, if each ERLS 1500 module is 15 cm wide and 30 cm long, then 10 ERLS 1500 modules can be used to form a 15 cm wide by 300 cm (3 meter) tall lighting arrangement, system 1510, on the riser 1520. This example may be more understandable by observing FIG. 15 and the explanations that follows,

FIG. 15 demonstrates a schematic representation of a system 1510 of the present invention. Each ERLS 1500 is modular and arranged adjacent to each other lengthwise to form a linear array (system 1510). The ERLS 1500 modules can be affixed onto the riser (i.e., a cement column) by the use of screws, clips, adhesive among other appropriate provisions that make the system withstand harsh environmental elements for years. It is understood that plugs and sockets are integrated within the ERLS 1500 modules to provide power and maintain communication from one ERLS 1500 module to the next ERLS 1500 module according to the present invention. The plugs and sockets must comply with the required standards and must withstand harsh environmental elements for years also.

### Example 2

In another example, the systems of the present invention can be applied to the perimeter of a building horizontally rather than vertically as illustrated in Example 1 above. The number of ERLS modules in Example 2 can be in the hundreds. The ERLS modules can be programmed to progressively chase each other and/or change color in predetermined intervals as contemplated in the present invention.

Although the illuminated modules and/or systems and methods for manufacturing the same have been described with reference to specific modules and/or systems, various changes may be made without departing from the spirit or scope of the disclosure herein. Various examples of such changes have been given in the foregoing description. As another example, although the different modules and/or systems described herein have been shown as substantially square or rectangular, there may be systems with modules and/or systems comprising other geometric shapes, such as circles, triangles, pentagons, or hexagons. As a further example, modules and/or systems may be provided without an upper surface, allowing another party to affix a desired upper surface during installation of the modules and/or systems as long as the environmental resistant aspects of the system complies with the standards established and such standards are not compromised and these and other modifications would not interfere with or depart from the concepts described herein.

Accordingly, the disclosure of the illuminated modules and/or systems and methods for manufacturing the same is intended to be illustrative of the scope of the application and is not intended to be limiting. It is intended that the scope of this application shall be limited only to the extent required by the appended claims. For example, it will be readily apparent that the illuminated modules and/or systems and methods for manufacturing the same discussed herein may be implemented in a variety of modules and/or systems, and that the foregoing discussion of certain of these modules and/or systems does not necessarily represent a complete description of all possible modules and/or systems. Therefore, the detailed description of the drawings, and the drawings themselves, disclose at least one preferred modules and/or systems of the illuminated modules and/or systems and methods for manufacturing the same, and may disclose alternative modules and/or systems and methods for manufacturing the same.

All elements claimed in any particular claim are essential to the modular back lighting system claimed in that particular claim. Consequently, replacement of one or more claimed elements constitutes reconstruction and not repair. Additionally, benefits, other advantages, and solutions to problems have been described with regard to specific modules. The benefits, advantages, solutions to problems, and any element or elements that may cause any benefit, advantage, or solution to occur or become more pronounced, however, are not to be construed as critical, required, or essential features or elements of any or all of the claims.

Moreover, modules and/or systems and limitations disclosed herein are not dedicated to the public under the doctrine of dedication if the modules and/or system limitations: (1) are not expressly claimed in the claims; and (2) are or are potentially equivalents of express elements and/or limitations in the claims under the doctrine of equivalents.

1. A modular lighting system, comprising:
at least one organic light emitting diode as a light source;
the at least one organic light emitting diode enclosed within an enclosure to form the module; and
the module being environmentally resistant to intrusion of particles to at least meet IP 67 standards.

2. The module of claim 1 adapted to form a system;
the system being environmentally resistant to intrusion of particles to at least meet IP 67 standards.

3. The system of claim 2 used for backlighting applications.

4. The system of claim 2 adapted to receive commands wirelessly from an external command and control center.

5. The system of claim 4 adapted to receive commands wirelessly according to ZigBee standards.

6. The system of claim 4 adapted to receive commands wirelessly according to Blue Tooth standards.

7. The command and control center of claim 4 adapted to transmit commands wirelessly according to Wi-Fi standards.
